(19) United States
(12) Patent Application Publication
(10) Pub. No.: US 2014/0316041 A1
(43) Pub. Date: Oct. 23, 2014

(54) ALTERNATIVE APPROACH TO TOUGHENING AND FLEXIBILIZING THERMOPLASTIC AND THERMOSET POLYMERS

(71) Applicant: Veerag Mehta, Plainsboro, NJ (US)

(72) Inventor: Veerag Mehta, Plainsboro, NJ (US)

(21) Appl. No.: 14/257,032

(22) Filed: Apr. 21, 2014

Related U.S. Application Data
(60) Provisional application No. 61/814,362, filed on Apr. 22, 2013.

(51) Int. Cl. C08L 83/04; C08L 21/00; C08L 77/06

(52) U.S. Cl. CPC C08L 83/04; C08L 77/06; C08L 21/00
USPC 524/323; 524/538; 524/506

(57) ABSTRACT

A composition of matter comprising a thermoplastic or thermoset polymer blended with a polysiloxane base and optionally adjuvents.

The present invention deals with a process for providing a thermoplastic or thermoset resin composition. This invention claims priority from U.S. Provisional Ser. No. 61/814,362, filed Apr. 22, 2013.

### BACKGROUND OF THE INVENTION

There are many obstacles to developing a multi-purpose flexible polymer composition. Polymers are widely used in many various applications. Through modification, the properties of polymers can be tailored for an intended performance. These applications include, but are net limited to, automotive, construction, oil field, packaging, including tubing, hoses and cable jackets, as well as, a number of other applications and compositions. These applications require high flexibility and/or improved impact strength across a wide range of temperatures. These attributes are generally attained by the addition of a plasticizer additive.

Traditional plasticizers provide flexibility in the end use product. The most common mechanism by which they work is that they have partial solubility in the polymer to which they are added, so they blend and disperse easily. Once dispersed in the polymer matrix, they create spacing between the polymer chains, lowering the glass transition temperature, and thus increasing the flexibility.

Plasticizer additives, though they perform well in many applications, they have any issues, such as a limited performance range and a negative eco-toxicological aspects. For example, sulfonamides, such as N-ethyl-ortho/para-toluenesulfonamide and N-Butylbenzenesulfonamide, are commonly used in commercial and industrial applications for imparting flexibility and/or impact strength to various polyamides. Sulfonamides can be used with a number of polyamide compositions across a wider range of temperature than with water or N-alkylpyrrolidones. Sulfonamides are suspect for a wide range to eco-toxicological properties, such as reports of neurotoxicity and accumulation in surface waters. In addition, they are limited in performance below −25° C. and in temperatures over 150° C. they are known for volatilizing out of the polyamide resin.

Again using a polyamide 6 or polyamide 66 resin as an example, water is also used as a plasticizer. Though water has a good eco-toxicological profile, it is limited in its use across a wide range of temperatures due to its melting point at 0° C. and its boiling point of 100° C.; essentially affecting its low temperature brittleness performance and its volatility at higher temperature. These aspects greatly affect the performance properties of the various polyamide compositions where is used. Water is also quite limited to use in more “exotic” polyamide compositions that require higher compounding temperatures, thus resulting in significant loss of the additive.

The market requires an improvement on existing technologies, as well as, potential new applications, such as, automotive, construction oil field, packaging, including tubing, hoses and cable jackets, as well as, a number of other applications and compositions. This invention, potentially, will open new avenues for various polymer compositions, in existing, more technologically difficult areas, as well as new market potentials.

This invention describes a novel composition to improve on all aspects of the existing technology of additive to improve flexibility and/or impact strength of a wide range of polymer compositions. This technology is novel because it does not rely on interference of hydrogen bonding between polymer chains to exhibits its performance properties as does the current industrial technologies. Additionally, the described technology can be utilized over a vast range of temperatures from leas than −50° C. to greater 400° C.

An additional aspect is the greatly improved eco-toxicological profile. The materials used as an additive in this invention are commonly used in a number of applications for indirect and direct food contact. Due to its high molecular weight, these additives are not metabolized by various living creatures.

The purpose of this invention is the use of a modified organo-silicone additive in place of the conventional technologies used in a wide range of polymer compositions and constructions. This invention is particularly useful in automotive, construction, oil field, packaging, including tubing, hoses, wire and cable, containers for food or general packaging, electrical connectors, protective covers, specialty films, automotive components, industrial housings, sporting good, footwear, fibers, foam, as well as, a number of other applications and compositions. These are all products that can be made by conventional polymer processing.

### THE INVENTION

Thus, what is disclosed and claimed herein is a composition of matter comprising a blend of 20 to 98 weight percent of a thermoplastic resin and, 2 to 80 weight percent of an ultra-high molecular weight polysiloxane having a molecular weight (Mn) of at least 10,000 and not more than about 1,000,000 (Mn), wherein the ultra-high molecular weight polydimethylsiloxane has blended with it 3 to 35 weight percent of a silica selected from the group consisting of precipitated silica and fumed silica.

The ultra-high molecular weight polydimethylsiloxane has pendant groups, terminal groups, or mixtures of pendant groups and terminal groups, selected from the group consisting of hydrogen, trimethyl, dimethyl, methyl, phenyl, fluoro, amino, vinyl, hydroxyl, and methacrylate.

In another embodiment, there is a composition of matter comprising a blend of 20 to 98 weight percent of a thermoset resin and, 2 to 80 weight percent of an ultra-high molecular weight polysiloxane having a molecular weight (Mn) of at least 10,000 and not more than about 1,000,000 (Mn), wherein the ultra-high molecular weight polydimethylsiloxane has blended with it 3 to 35 weight percent of a silica selected from the group consisting of precipitated silica and fumed silica.

The ultra-high molecular weight polydimethylsiloxane has pendant groups, terminal groups, or mixtures of pendant groups and terminal groups, selected from the group consisting of hydrogen, trimethyl, dimethyl, methyl, phenyl, fluoro, amino, vinyl, hydroxyl, and methacrylate.

In addition there is a composition of matter comprising a blend of 20 to 98 weight percent of a thermoset rubber and 2 to 80 weight percent of an ultra-high molecular weight polysiloxane having a molecular weight (Mn) of at least 10,000 and not more than about 1,000,000 (Mn), wherein the ultra-high molecular weight polydimethylsiloxane has blended with it 3 to 35 weight percent of a silica selected from the group consisting of precipitated silica and fumed silica.

The ultra-high molecular weight polydimethylsiloxane has pendant groups, terminal groups, or mixtures of pendant groups and terminal groups, selected from the group consisting of hydrogen, trimethyl, dimethyl, methyl, phenyl, fluoro, amino, vinyl, hydroxyl, and methacrylate.

### DETAILED DESCRIPTION OF THE INVENTION

Thus, the invention herein is a composition that is provided by blending a thermoplastic or thermoset polymer, such as resins or rubbers with an ultra-high molecular weight polysiloxane base.

The thermoplastic polymer can be selected from the group consisting of polystyrene, high impact polystyrene, polypropylene, polycarbonate, polysulfone, poly(phenylene sulfide), acrylonitrile-butadiene-styrene copolymer, nylon, acetal, polyethylene, polyketones, poly(ethylene terephthalate), poly(butylene terephthalate), acrylate, fluoroplastics, polyesters, phenolics, epoxies, urethanes, polyimides, melamine formaldehyde and urea, among others. Blends of these polymers are contemplated within the scope of this invention.

Useful thermoset polymers are polyesters, polyurethanes, rubbers, phenol-formaldehyde, urea-formaldehyde, melamines, epoxy, polyimides and polycyanurates, among others. Blends of these polymers are contemplated within the scope of this inventions.

Typically, these polymers are used in a ratio of 20 weight percent to 98 weight percent to 80 to 2 weight percent of the ultra-high molecular weight polysiloxane base. More preferably, the polymers are used at 50 weight percent to 98 weight percent and most preferably, the polymers are used at 70 to 98 weight percent all based on the weight of the polymer and the polysiloxane base.

The polymers are blended with 2 to 80 weight percent of ultra-high molecular weight polysiloxane bases. The polysiloxanes in such bases have pendant groups, terminal groups, or mixtures of pendant groups and terminal groups selected from groups such as trimethyl, dimethyl, methyl, phenyl, fluoro, amino, vinyl, hydroxyl, and methacrylate to mention a few.

The silica in such bases consists primarily of precipitated and fumed silicas. The silica is present in the range of 3 to 35 weight percent based on the weight of the silica and the polysiloxane. A more preferred range for the silica is 15 to 25 weight percent.

The preferred polysiloxanes for this invention are polydimethyl-siloxanes having either hydroxydimethyl termination, vinyldimethyl termination, trimethylsiloxy termination or, the above-mentioned materials wherein there are pendant groups as set forth Supra. What is meant by “ultra-high molecular weight” is that the polysiloxanes have a molecular weight (Mn) of at least 10,000 and not more than about 1,000,000 (Mn). Preferred is an Mn of 50,000 to 500,000 and most preferred is an Mn of 250,000 to 350,000. When the molecular weight is below 10,000, the resultant silicone base may not be as effective. When the molecular weight is above 1,000,000, blending the polysiloxane with silica becomes difficult to disperse, but such a polysiloxane can still be employed.

The blends are prepared by known methods in the industry and do not entail complex manufacturing.

Other materials or adjuvents can be added to the blends depending on which properties one wishes to enhance. For example, one can add compatibilizer. Such compatibilizers are known in the art and can be selected based on the type of thermoplastic or thermoset polymer and the kind of functionality it has. Typical compatibilizers include polymers and oligomers that are block and/or graft co-, tert-, tetra-polymers or oligomers with groups that include, but are not limited to, ethylene, propylene, butylene, butadiene, vinyl, maleic anhydride, vinyl acetate, carboxylic acid, acrylic acids, lactic acid, esters, silanes, dimethylsiloxanes, styrene, ether, acrylates, epoxides, oxides, dienes, cyanurate, urethane, quinone, azalactone, sulfonate, chloride, fluoride, imide, ketones, vinyl, phenyl, hydroxyl, epoxy, methoxy, amide, imide, isoprene, hexane, octane, decane, and dodecane. The compatibilizer can be added during the blending of the polymer with the ultra-high molecular weight polysiloxane base.

Plasticizers can also be added to the blend of the polysiloxane base and the polymer, such plasticizers can be, for example, Dicarboxylic/tricarboxylic ester-based plasticizers such as, phthalate-based plasticizers: Bis(2-ethylhexyl) phthalate (DEHP), Di(2-ethylhexyl) Phthalate, Diisononyl phthalate (DINP), Di-n-butyl phthalate (DnBP, DBP), Butyl benzyl phthalate (BBzP), Diisodecyl phthalate (DIDP), Di-n-octyl phthalate (DOP or DnOP), Diisooctyl phthalate (DIOP), Diethyl phthalate (DEP), Diisobutyl phthalate (DIBP), Di-n-hexyl phthalate, di-2-ethylhexyl phthalate, Butyl Benzene Phthalate, Di-isoNonyl Phthalate, Di-isoDecyl Phthalate, Dipropylheptyl phthalate, Diundecyl phthalate, Diisoundecyl phthalate, Ditridecyl phthalate, Dibutyl phthalate, Diisobutyl phthalate, Diidobutyl phthalate, Diisoheptyl phthalate, Dipropyl phthalate, Dimethyl phthalate; Trimellitates such as, Trimethyl trimellitate (TMTM), Tri-(2-ethylhexyl) trimellitate (TEHTM-MG), Tri-(n-octyl,n-decyl) trimellitate (ATM), Tri-(heptyl,nonyl) trimellitate (LTM), n-octyl trimellitate (OTM), Trioctyl trimellitate/Tris(2-ethylhexyl)trimellitate; Adipates, sebacates, maleates, such as, Bis(2-ethylhexyl)adipate (DEHA), Dimethyl adipate (DMAD), Monomethyl adipate (MMAD), Dioctyl adipate (DOA), Dibutyl sebacate (DES), Dibutyl maleate (DBM), Diisobutyl maleate (DIBM), di(butoxyethyl)adipate, Dibutoxyethoxyethyladipate, Di (2-ethyl hexyl) adipate, and, Dioctyl adipate/Bis(2-ethylhexyl)adipate.

Other plasticizers include Benzoates, Terephthalates such as Dioctyl terephthalate/DEHT, Glyceryl tribenzoate, 1,4-cyclohexanedimethanol dibenzoate, Polypropylene glycol dibenzoate, Neopentyl glycol dibenzoate, 1,2-Cyclohexane dicarboxylic acid diisononyl ester, Epoxidized vegetable oils, alkyl sulphonic acid phenyl ester (ASE), Sulfonamides, N-ethyl toluene sulfonamide (o/p ETSA), ortho and para isomers, N-(2-hydroxypropyl) benzene sulfonamide (HP BSA), N-Ethyl-o/p-toluene sulfonamide, N-(n-butyl) benzene sulfonamide (BBSA-NBBS), N-butylbenzene sulfonamide, Organophosphates, Dipropylene glycol dibenzoate, dipropylene glycol 1,4-cyclohexane dimethanol dibenzoate, triethyl phosphate, triisopropyl phenyl phosphate, Tricresyl phosphate (TCP), Tributyl phosphate (TEP), e-ethylhexyldiphenyl phosphate, Dioctyl phosphate, isoDecyl diphenyl phosphate, triphenyl phosphate, triaryl phosphate synthetic, tributoxyethyl phosphate, tris-(chloroethyl) phosphate, butyphenyl diphenyl phosphate, chlorinated organic phosphate, cresyl diphenyl phosphate, tris-(dichloropropyl) phosphate, isopropylphenyl diphenyl phosphate, trixenyl phosphate, tricresyl phosphate, diphenyl octyl phosphate, Glycols/polyethers, Triethylene glycol dihexanoate (3G6, 3GH), Tetraethylene glycol diheptanoate (4G7), Polymeric plasticizers, Polybutene, N-n-butylbenzenesulphonamide, Triethyleneglycol bis (2-ethylhexanoate), N-ethyl o/p-toluene sulfonamide, PEG di-2-ethylhexoate, PEG—di laurate, Triethyl acetyl citrate, Acetyl tributyl citrate, Triethylene glycol bis(2-ethylhexanoate), Dioctyl terephthalate/Bis(2-ethylhexyl)-1,4-benzenedicarboxylate, Dioctyl succinate/Bis(2-ethylhexyl)succinate, Dioctyl succinate/Bis(2-ethylhexyl)succinate and Biodegradable plasticizers such as Acetylated monoglycerides, Alkyl citrates, Triethyl citrate (TEC), Acetyl triethyl citrate (ATEC), Tributyl citrate (TBC), Acetyl tributyl citrate (ATBC), Trioctyl citrate (TOC), Acetyl trioctyl citrate (ATOC), Trihexyl citrate (THC), Acetyl trihexyl citrate (ATHC), Butyryl trihexyl citrate (BTHC, trihexyl o-butyryl citrate), Trimethyl citrate (TMC). Plasticizers for energetic materials such as Nitro glycerine (NG, aka “nitro”, glyceryl trinitrate), Butanetriol trinitrate (BTTN), Dinitrotoluene (DNT), Trimethylolethane trinitrate (TMETN, aka Metriol trinitrate, METN), Diethylene glycol dinitrate (DEGDN, less commonly DEGN), Triethylene glycol dinitrate (TEGDN, less commonly TEGN), Bis(2,2-dinitropropyl)formal (BDNPF), Bis (2,2-dimitropropyl)acetal (BDNPA), 2,2,2-Trinitroethyl 2-nitroxyethyl ether (TNEN), Epoxy esters, Phosphate Esters, Secondary Plasticizers, Epoxidized soybean oil (ESBO) and Epoxidized linseed oil (ELO), Cyclohexane diacids esters: Di-isononyl cyclohexane dicarboxylate, Triglyceride plasticizers: Tris-2-ethyhexyl trimellitate (Tri-octyl Trimellitate—TOTM), Tri (2-ethyl hexyl) trimellitate, Glycerol Acetylated esters, Di-(2-ethyl hexyl terephthalate), Di-(iso nonyl) cyclohexane 1-2 di carboxylic acid ester, Di-(2-ethyl hexyl) acetate, and 2-Ethyl hexyl adipates.

Other adjuvents that can be added as desired by the user include glass fibers, glass beads, mineral fillers, flame retardants, stabilizers, antioxidants, glass bubbles, polymeric fibers, carbon fibers, pigments, process aids, lubricants, and mixtures of any of the adjuvents.

The adjuvents can be blended with the ultra-high molecular weight polysiloxanes and silica blend prior to addition to the thermoplastic polymer or they can added directly to the combination of polymer and polysiloxane base.

The polysiloxane base and the polymer are intimately blended and the blend can be applied, for example, as a coating to the outside of a wire or covered metal strand and then cured through known methods.

The materials are formulated, for example using polyamide 6 resin, which renders the resin flexible enough for use in THHN wire and cable and can be used instead of relying on caprolactam as an additive in nylon resins, to make the product acceptable. The additional benefit of this approach allows the material to be flexible regardless of moisture content in the polymer. Also, it allows it to be flexible down to −40° C.

The following examples are presented to better illustrate the method of the present invention. The materials used in the following examples were: precipitated silica with a surface area of 250 g/m² and average particle size of 9 microns; An ultra high molecular weight polysiloxane with a mn of 55,000 and a 100 pm level of vinyl termination. A general purpose Nylon 66 resin with a viscosity value of 150. Polyamide 12 with a melt volume rate of 0.15 in³/10 min. A zinc based ionomer based on ethylene acrylic acid. A sterically hindered phenolic primary antioxidant for processing and long-term thermal stabilization, a natural acetal copolymer with a melt flow index of 9 g/10 min. A Thermoplastic Polyurethane Elastomer (Polyester) (TPU-Polyester) material with a specific gravity of 1.20. A random copolymer of Ethylene and Methyl Acrylate with a melt flow index of 8 g/10 min.

### Example 1: Polyamido 12 Blends

The material can be prepared in two steps. In the first step the precipitated silica was blended into the ultra-high molecular weight polysiloxane. This base was prepared at room temperature in a 25 mm twin screw extruder wherein 25 weight percent silica, and 75% silicone gum. This blend (Blend 1) is then used in the next step.

In the second step, the twin screw extruder was heated to 250° C. and used to mix the 12% of the silicone base from step 1, 3% ionomer, and 85% polyamide 12. The resulting material had 412% elongation and 756.8 MPa flexural modulus compared to the natural polyamide 12 that had an elongation of 125% and a flexural modulus of 1103 MPa.

### Example 12: Polyamide 66 Blends

This material was prepared in 2 steps. In step one 22% of the precipitated silica was blended along with 0.5% of the phenolic antioxidant and 77.5% of the ultra-high molecular weight polysiloxane using a twin screw extruder.

In the second step, the base from step one was blended on a twin screw extruder with the polyamide 66 resin to make a composition of 20% polysiloxane base and 80% polyamide 66. The resulting material has 51.7% elongation and 1545.6 MPa flexural modulus.

### Example 3: Acetal Blends

This material was prepared in 2 steps. In step one, 18% of the precipitated silica was blended along with 0.5% of the phenolic antioxidant and 81.5% of the ultra-high molecular weight polysiloxane using a twin screw extruder.

The polysiloxane base from step one was blended on a twin screw extruder at 190° for a composition of 15% polysiloxane base, 1.25% ethylene methyl acrylate copolymer, 3.75% thermoplastic polyurethane, 0.5% phenolic antioxidant, and 78.5% copolymer acetal. The resulting material had a flexural modulus of 1651 MPa compared to 2595 MPa of the original acetal copolymer resin.

What is claimed is:

1. A composition of matter comprising a blend of:
i. 20 to 98 weight percent of a thermoplastic resin and,
ii 2 to 80 weight percent of an ultra-high molecular weight polysiloxane having a molecular weight (Mn) of at least 10,000 and not more than about 1,000,000 (Mn,), wherein the ultra-high molecular weight polydimethylsiloxane has blended with it 3 to 35 weight percent of a silica selected from the group consisting of:
a. precipitated silica and,
b. fumed silica,
wherein the ultra-high molecular weight polydimethylsiloxane has pendant groups, terminal groups or mixtures of pendant groups and terminal groups selected from the group consisting of hydrogen, trimethyl, dimethyl, methyl, phenyl, fluoro, amino, vinyl, hydroxyl, and methacrylate.

2. A composition of matter as claimed in claim 1 wherein the silica is present in the range of 15 to 25 weight percent.

3. A composition of matter as claimed in claim 1 wherein the thermoplastic resin is present at 50 to 98 weight percent.

4. A composition of matter as claimed in claim 1 wherein the thermoplastic resin is present at 70 to 95 weight percent.

5. A composition of matter as claimed in claim 1 wherein the ultra-high molecular weight polysiloxane is a hydroxyl terminated polydimethylsiloxane.

6. A composition of matter as claimed in claim 1 wherein the ultra-high molecular weight polysiloxane is a trimethylsiloxy terminated polydimethylsiloxane.

7. A composition of matter as claimed in claim 1 wherein the composition of matter contains, in addition, a compatibilizer.

8. A composition of matter as claimed in claim 7 wherein the compatibilizer is added during the blending of the thermoplastic polymer with the ultra-high molecular weight polysiloxane.

9. A composition of matter as claimed in claim 1 wherein, in addition, there is also present in the composition an adjunct selected from the group consisting of:
i. glass fiber,
ii. glass beads,
iii. mineral fillers,
iv. flame retardant,
v. stabilizer,
vi. antioxidant,
vii. glass bubbles,
viii. polymeric fibers,
ix. carbon fibers,
x. pigments,
xi. process aids,
xii. lubricants, and,
xiii. mixtures of any of i. to xii.

10. A composition as claimed in claim 9 wherein said adjuvents are blended with the ultra-high molecular weight polysiloxane and silica blend prior to addition to the thermoplastic polymer.

11. A composition of matter as claimed in claim 1 wherein the thermoplastic polymer is selected from the group consisting of: polystyrene, high impact polystyrene, polypropylene, polycarbonate, polysulfone, poly(phenylene sulfide), acrylonitrile-butadiene-styrene copolymer, nylon, acetal, polyethylene, poly(ethylene terephthalate), poly(butylene terephthalate), polyketone, acrylate, fluoroplastics, polyesters, phenolics, epoxies, urethanes, polyimides, melamine formaldehyde and urea.

12. A composition of matter as claimed in claim 11 wherein the thermoplastic polymer is selected from a blend of one or more thermoplastic polymers.

13. A composition of matter as claimed in claim 1 wherein, in addition, there is present a plasticizer.

14. A composition of matter claimed in claim 13 wherein there is a blend of plasticizers.

15. The composition of claim 13 wherein the plasticizer compound is present at 1 to 30 weight percent.

16. The composition of claim 13 wherein the plasticizer is present at 2 to 8 weight percent.

17. A composition of matter comprising a blend of:
i. 20 to 98 weight percent of a thermoset resin and,
ii. 2 to 80 weight percent of an ultra-high molecular weight polysiloxane having a molecular weight (Mn) of at least 10,000 and not more than about 1,000,000 (Mn,), wherein the ultra-high molecular weight polydimethylsiloxane has blended with it 3 to 35 weight percent of a silica selected from the group consisting of:
a. precipitated silica and,
b. fumed silica,
wherein the ultra-high molecular weight polydimethylsiloxane has pendant groups, terminal groups or mixtures of pendant groups and terminal groups selected from the group consisting of hydrogen, trimethyl, dimethyl, methyl, phenyl, fluoro, amino, vinyl, hydroxyl, and methacrylate.

18. A composition of matter comprising a blend of:
i. 25 to 98 weight percent of a thermoset rubber and,
ii. 2 to 75 weight percent of an ultra-high molecular weight polysiloxane having a molecular weight (Mn) of at least 10,000 and not more than about 1,000,000 (Mn,), wherein the ultra-high molecular weight polydimethylsiloxane has blended with it 3 to 35 weight percent of a silica selected from the group consisting of:
a. precipitated silica and,
b. fumed silica,
wherein the ultra-high molecular weight polydimethylsiloxane has pendant groups, terminal groups or mixtures of pendant groups and terminal groups selected from the group consisting of hydrogen, trimethyl, dimethyl, methyl, phenyl, fluoro, amino, vinyl, hydroxyl, and methacrylate.

19. In combination, a composition as claimed in claim 1 and a wire.

20. In combination, a composition as claimed in claim 1 and a cable.

21. In combination, a composition as claimed in claim 1 and a film.

22. In combination, a composition as claimed in claim 1 and a fiber.

23. In combination, a composition as claimed in claim 1 and a molded container or housing.

24. In combination, a composition as claimed in claim 1 and a extruded sheet.

25. In combination, a composition as claimed in claim 1 and a hose.

26. In combination, a composition as claimed in claim 1 and a tube.

27. In combination, a composition as claimed in claim 1 and a fiber.

28. In combination, a composition as claimed in claim 1 and an article used in sporting goods.
